(19) United States
(12) Patent Application Publication
(10) Pub. No.: US 2009/0240874 A1
(43) Pub. Date: Sep. 24, 2009

(54) FRAMEWORK FOR USER-LEVEL PACKET PROCESSING

(76) Inventor: Fong Pong, Mountain View, CA (US)

Correspondence Address: BRAKE HUGHES BELLERMANN LLP;c/o CPA Global, P.O. Box 52050, Minneapolis, MN, 55402, US

(21) Appl. No.: 12/396,459

(22) Filed: Mar. 2, 2009

Related U.S. Application Data
(60) Provisional application No. 61/032,800, filed on Feb. 29, 2008.

(51) Int. Cl. H04L 12/56; G06F 12/00; G06F 12/08; G06F 12/02

(52) U.S. Cl. 711/105; 370/389; 370/412; 711/154; 711/118; 711/170; 711/104; 711/E12.001; 711/E12.017; 711/E12.008

(57) ABSTRACT

A method of processing network packets can include allocating a first portion of a physical memory device to kernel-space control and allocating a second portion of the physical memory device to direct user-space process control. Network packets can be received from a computer network, and the received network packets can be written to the second portion of the physical memory without writing the received packets to the first portion of the physical memory. The network packets can be processed with a user-space application program that directly accesses the packets that have been written to the second portion of physical memory, and the processed packets can be sent over the computer network

### CROSS-REFERENCE TO RELATED APPLICATION

This application claims priority to U.S. Provisional Application No. 61/032,800, filed on Feb. 29, 2008, entitled “Framework For User-Level Packet Processing,” which is incorporated by reference herein in its entirety.

### TECHNICAL FIELD

This description relates to computing systems.

### BACKGROUND

Network packet processing has exhibited growing complexity, as more services and functionality continue to be incorporated in today's network infrastructure, including network address and port translation (“NAPT”), packet forwarding, and flow classifications. Such network services may involve high-level per-packet processing, in particular, at the network edge. As a result, they frequently require dedicated or specialized devices aimed to accelerate packet processing for realizing wire-speed NAPT, anti-spam gateways and application firewalls, and content caching. Network packet processing can include a wide range of functionality and services, which roughly fall into two classes: header-processing applications (e.g., NAT, protocol conversion, firewall services, etc.) and payload-processing application (e.g., intrusion detection, content-based load balancing, etc.). Network packet processing can include a wide range of functionality and services, which roughly fall into two classes: header-processing applications (e.g., NAT, protocol conversion, firewall services, etc.) and payload-processing application (e.g., intrusion detection, content-based load balancing, etc.).

The use of specialized or customized hardware devices to obtain high-performance network packet processing can be expensive in terms of total-cost-of-ownership, can be subject to high deployment and management problems, can involve long time-to-market cycles and proprietary microcode development challenges, and can lack flexibility in rectifying any functionality. Solutions based on field programmable gate arrays (“FPGA”) have been pursued as well, yet such solutions often require a high degree of effort to accommodate new services or applications or to modify existing services or applications. On the other hand, general-purpose processors enjoy excellent flexibility and benefit from a rich software pool in existence, such as operating systems, libraries, and utilities and tools available for rapid packet processing application development. However, despite their relatively low cost and high degree of programmability, general-purpose processors are generally considered to yield unacceptable performance in packet processing.

### SUMMARY

The details of one or more implementations of a framework for user-level packet processing are set forth in the accompanying drawings and the description below. Other features will be apparent from the description and drawings, and from the claims.

### BRIEF DESCRIPTION OF THE FIGURES

FIG. 1 is a schematic diagram of networking device that can process network packets using Ethereal memory.

FIG. 2 is a schematic diagram of system-on-a-chip processor for performing network processing with Ethereal Memory.

FIG. 3 is a graph that shows the average latency for various sizes of data transfers.

FIG. 4 is a graph showing throughput as a function of data transfer size for different transmission protocols.

FIG. 5 is a schematic diagram of a client-server configuration in which a network device performs Application-layer Packet Processing through EthereAL (APPEAL) memory.

FIG. 6 is a graph of packet elapse time as a function of the number of connections under the APPEAL setting.

FIG. 7 is a graph of packet elapse time as a function of the number of connections under the APPEAL setting.

FIG. 8 is a flow chart of a process of processing network packets.

### DETAILED DESCRIPTION

Network processors (“NPs”) have been developed to meet the twin goals of fast packet processing that is generally achievable by specialized hardware solutions and good flexibility that is generally obtainable through general-purpose platforms. As NPs have to meet stringent throughput and packet processing latency requirements, it is considered to be a demanding challenge to design an NP, which usually involves trade-offs between many design options to arrive at a good compromise among various conflicting criteria. Commonly based on a chip multiprocessor style involving up to tens of simple execution cores (also known as micro engines or processing elements), current NPs attempt to provide wire-speed packet processing while preserving general-purpose programmability, with limited on-chip memory resources. The micro engines operate on the data processing path and are controlled and assigned data for task execution by a separate control core. As a result, the various cores in the NP operate in a master-slave fashion, with only the control core running a certain embedded OS kernel. Separating the control core from other execution cores is designed to achieve high throughput, since it is more economical to implement a large number of simple processing engines to perform various functions than to have a single core perform all functions. For example, the Intel® IXP 2850 contains one processor control core (referred to as the Intel® Xscale core) plus 16 micro engines, each having a small local memory of 640 words plus 4 banks of 128 registers as receiving/transmitting buffers, which significantly compromises programmability of the micro engines. While NPs are intended to be programmable for adapting new packet processing services or traffic pattern changes, they are often found to be hard to program.

Multi-core processor chips, such as, for example, the Intel® Core 2 Extreme and the Broadcom BCM 1480 SoC (“System-on-a-Chip”) processor chips, also can be used for network packet processing using applications based on a general-purpose operating system platform. With multi-core processor chips, each core is general and powerful enough to run a Linux kernel able to support application software execution for handling different functions and services individually. This makes it possible to develop application-layer packet processing software executed on cores of such a general-purpose processor, thereby eliminating the need for making changes to operating systems and fully taking advantage of rich libraries and utilities/tools available for rapid development, without concerning detailed resource management or process/thread scheduling. Additionally, application-layer programs are easy to write and debug. They are also more portable and easier to profile and conduct performance tuning than kernel modules. The addition and upgrade of user-space service modules are as simple as launching new programs. However, because packet processing software is then run in the application layer while packets are received and transmitted by the kernel, expensive memory copies are needed between kernel space and user space, besides heavy kernel overhead caused by interrupt and system call handling, memory buffer management, among others.

Therefore, as described herein, an architectural framework is designed to enable application-layer packet processing while avoiding costly kernel overhead, which ensures high throughput and low processing latency. This is achieved by creating a memory address space known herein as “Ethereal memory,” which is not available to the kernel, from the physical memory that otherwise would be controlled by the kernel. The Ethereal memory is shared by application programs and network interface drivers and provides Application-layer Packet Processing through EthereAL (APPEAL) memory. It should be noted that although this Ethereal memory address space can be located on the same physical memory chip as the memory address space used by the kernel, the Ethereal memory is shielded from the kernel and is under the complete control of application programs. Therefore, application programs have visibility to a hardware resource (i.e., the Ethereal memory) and enjoy the greatest degree in processing data contained therein without kernel overhead. With this APPEAL approach, the use of general-purpose, multi-core processors can attain very high performance levels despite application software being written in the C programming language and run on a core where a Linux kernel exists.

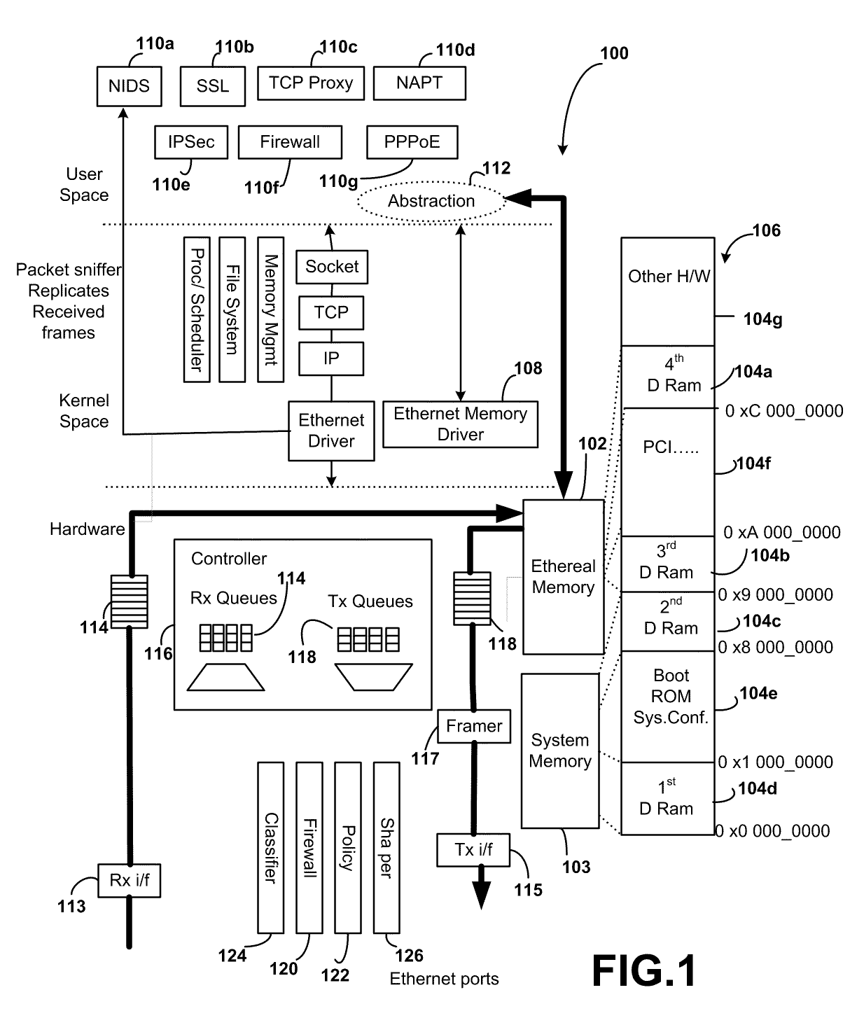

As shown FIG. 1 below, a proposed Ethereal Memory architecture is shown in the context of a networking device 100. As shown in FIG. 1, Ethereal Memory 102 can reside in the physical memory address space 104a and 104b of a memory chip (e.g., a single dynamic random access (“DRAM”)) 106, as being addressable by hardware agents in the regular manner. In this particular example, the physical address map of a multicore processor system on a chip (“SoC”) (e.g., Broadcom's BCM 1480 SoC) includes four 256 MB memory ranges 104a, 104b, 104c, and 104d whose physical addresses are shown in the memory map. The memory chip 106 also includes an address space 104e that can be used to store system configuration and boot instructions, an address space 104f used for Peripheral Component Interconnect (“PCI”) operations, and an address space 104g used for instructions relevant to other hardware operations.

By allocating an exact memory map of physical addresses 104c and 104d, which does not include all addresses in the physical memory, to the kernel (e.g., the Linux or Windows operating system) as a part of system memory 103 the top two 256 MB regions 104a and 104b (labeled 4^{th} DRAM and 3^{rd} DRAM) are purposely hidden from the kernel. Thus, the hidden regions 104a and 104b are not accessible to, or managed by, the kernel's memory manager. Instead, full control of the Ethereal Memory 102 is assumed by an Ethereal Memory Driver 108, which appears as a memory driver “dev/gmem.” The Ethereal memory 102 and the hardware interfaces are presented to user programs 110a, 110b, 110c, 110d, 110e, 110f, 110g, as a set of resources by an abstraction library 112. The user space programs 110a-g can include, for example, a network intrusion detection system (“NIDS”) program 110a that detects malicious activity such as denial of service attacks, port scans or attempts to crack into computers by monitoring network traffic. The NIDS program 110a can do this by reading all the incoming packets and trying to find suspicious patterns. If, for example, a large number of Transport Control Protocol (“TCP”) connection requests to a very large number of different ports are observed, one could assume that there is someone conducting a port scan of some or all of the computer(s) in the network. A Secure Socket Layer (“SSL”) or a Transport Layer Security (“TLS”) program 110b can provide a cryptographic protocols that provides security and data integrity for communications over TCP/IP networks such as the Internet. TLS and SSL encrypt the segments of network connections at the Transport Layer end-to-end. A TCP Proxy program 110c can act as an intermediary between two network nodes (e.g., a client and a server, such as a destination server). A node can establish connections to the TCP proxy, which then establishes a connection to the other node. The TCP proxy sends data received from the first node to the second node and forwards data received from the second node to the first node. A Network Address Port Translation (“NAPT”) program 110d can modify network address information in datagram packet headers while in transit across a traffic routing device for the purpose of remapping a given address space into another address space. For example, a NAPT program 110d can be used in conjunction with network masquerading (or IP masquerading) which is a technique that hides an entire address space, usually consisting of private network addresses, behind a single IP address in another, often public address space. The NAPT program 110d also can translate the transport identifier (e.g. the TCP port numbers to allow the transport identifiers of a number of private hosts to be multiplexed into the transport identifiers of a single public IP address. An Internet Protocol Security (“IPSec”) program 110e can provide a suite of protocols for securing Internet Protocol (“IP”) communications by authenticating and encrypting each IP packet of a data stream. The IPSec program 110e also can include protocols for establishing mutual authentication between agents at the beginning of the session and negotiation of cryptographic keys to be used during the session. The IPSec program 110e can be used to protect data flows between a pair of hosts (e.g. computer users or servers), between a pair of security gateways (e.g. routers or firewalls), or between a security gateway and a host. A firewall program 110f can provide an integrated collection of security measures designed to prevent unauthorized electronic access to a networked computer system. The firewall program 110f also can be configured to permit, deny, encrypt, decrypt, or proxy all computer traffic between different security domains based upon a set of rules and other criteria. For example, the firewall program 110f an be used to prevent unauthorized Internet users from accessing private networks connected to the Internet, especially intranets, by forcing all messages entering or leaving the intranet to pass through the firewall, which examines each message and blocks those that do not meet the specified security criteria. A Point-to-Point Protocol over Ethernet (“PPPoE”) program 110g can provide a network protocol for encapsulating Point-to-Point Protocol (“PPP”) frames inside Ethernet frames, and it can be used with Asymmetric Digital Subscriber Lines (“ADSL”) where individual users connect to the ADSL transceiver (modem) over Ethernet and in plain Metro Ethernet networks. By using PPPoE, users can virtually “dial” from one machine to another over an Ethernet network, establish a point to point connection between them and then securely transport data packets over the connection.

To allocate and solicit for the Ethereal memory 102 to run a user-space application, the abstraction layer 112 opens the Ethereal Memory device 102 with a file open operation. The user program 110a, 110b, 110c, 110d, 110e, 110f, or 110g then specifies the size of memory, I/O attributes such as the cacheability, and the preferred physical memory address via the “ioctl” command interface to the driver. The ioctl command interface is employed to allow user-space programs or code to communicate directly with hardware devices or kernel components. The driver 108 performs the allocation of virtual memory space from the calling process, the allocation of physical memory from the Ethereal Memory 102, and establishes the page table mapping between the two spaces. In this way, the user program 110a, 110b, 110c, 110d, 110e, 110f, or 110g will have full accesses to the Ethereal Memory 102 as usual. The abstraction layer 112 also assumes the responsibility for buffer management and presents a simple interface to the user processes for receiving and sending packets as described below.

The use of the Ethereal Memory 102 for packet buffers enables direct placement of packet data to user addressable memory locations, and thereby eliminates expensive memory copy operations between the kernel space and the user space. This is achieved by advertising Ethereal memory 102 to the receive queues 114 via the abstraction library that hides the details of the hardware and provide needed protections for not posting out-of-bound addresses to the hardware. Transmitting packets via transmit queues 118 is accomplished in similar ways, in that the user space program may prepare packet data in a buffer located in the Ethereal memory 102 and can subsequently post the request to a transmit queue 118 by the abstraction layer, which programs the hardware on behalf of the user process. Packets for transmission can be encapsulated in frames by a framer 117 and transmitted over a transmission interface 115.

In general, the framework imposes relatively few assumptions on the hardware. The interaction between the user-space software applications and the hardware is limited to, or done by accessing the receive queues 114 and the transmit queues 118. Placement of the receive queues 114 and the transmit queues 118 nonetheless influences the methods used to access them and subsequently the overhead associated with network packet processing. When the receive queues 114 and the transmit queues 118 are considered as hidden hardware resources, they are accessed via system calls to the (kernel) driver, which causes longer latency than when receive queues 114 and the transmit queues 118 are allocated from the Ethereal memory 102 and direct access to the receive queues 114 and the transmit queues 118 from the user-space application is possible without having to interrupt the user process to make a system call to the kernel. When receive queues 114 and the transmit queues 118 are allocated from the Ethereal memory 102 and direct access to the receive queues 114 and the transmit queues 118 from the user-space application is achieved without having to interrupt the user process to make a system call to the kernel, probing the receive queue 114 for incoming packets and the transmit queue 118 for send completion can be done efficiently.

Use of the Ethereal Memory 102 is non-intrusive and complementary to the existing kernel stack, and most existing network processing SoCs already can support the use of Ethereal Memory 102. For example, consider the illustrated port interface of FIG. 1. When a packet arrives over a receiver interface 113, a simple packet classifier 120 may parse and extract header fields, and make decisions based on set policies 122. The packet also can be passed through a hardware firewall 124 and a traffic shaper 126. Things such as the encapsulation formats (e.g. Point-to-Point Protocol over Ethernet (“PPPoE”)) and services identified by the protocol types (e.g. UDP/RTP, SIP, IP Multicast, etc.) can be decided quickly with relative simple hardware. Together with a policy database 122, the hardware can direct packets to suitable service programs via different receive queues 118. For example, latency-sensitive VoIP packets may be sent to the highest-priority receive queue 118, while multicast packets for IPTV service are sent to the second high-priority receive queue 118, and other packets for generic data services are sent to a low-priority queue 118.

The Ethernet Port block (i.e., the hardware block) can include a few modules. For example, the packet classifier module 120 can parse and extracts the header field that can be used for, for example, determining if the packet is PPPoE encapsulated; determining if the packet is a (UDP)/RTP packet that has a real-time constraint; determining if the packet is an IP multicast packet; determining if the packet is an iSCSI packet to port 3260; and/or determining if the packet is an SIP packet to port 5060. A simple firewall module 124 can support blocking, logging and alerting packets, such as, for example, “port-blocking”, which discards packets to illegal ports; “IP filtering”, which drops packets with illegal IP address; a “multicast filtering”, which rejects packets to un-subscribed multicast groups and which supports the internet protocol television (“IPTV”) services; and discard IP fragments whose length is shorter than a threshold value, which can be used to detect and alter DoS (Denial of Service) attacks. The Policy/Shaper Engine 122 and 126 can specify the rules of how the accepted packets are delivered to the user-space programs, and that outgoing packets are guaranteed with the bandwidth according to their QoS requirements. Based on defined rules, packets can be, for example, replicated so that a copy is sent of the received packet to the NIDS 110a for advanced intrusion detection. The rules may require injecting a packet Px to the receive queue 114 for a service program Sx, based on specified values found in the packet header. For example, a latency-sensitive VoIP packet using UDP/RTP should be added to highest-priority receive queue; a multicast packet for IPTV service should be queued at the 2^{nd}-high-priority Receive queue, and other packets for generic data services are queued at the low-priority queues. The policy engine also can specify the QoS requirement for outgoing packets. That is, the policy engine can dictate the transmitting engine to select the receive and send queues, where a set of send and receive queues are supported in the ETH port block (or in the Ethereal Memory). Each user-space service program may allocate its own send and receive queues, and advertise them to the ETH port.

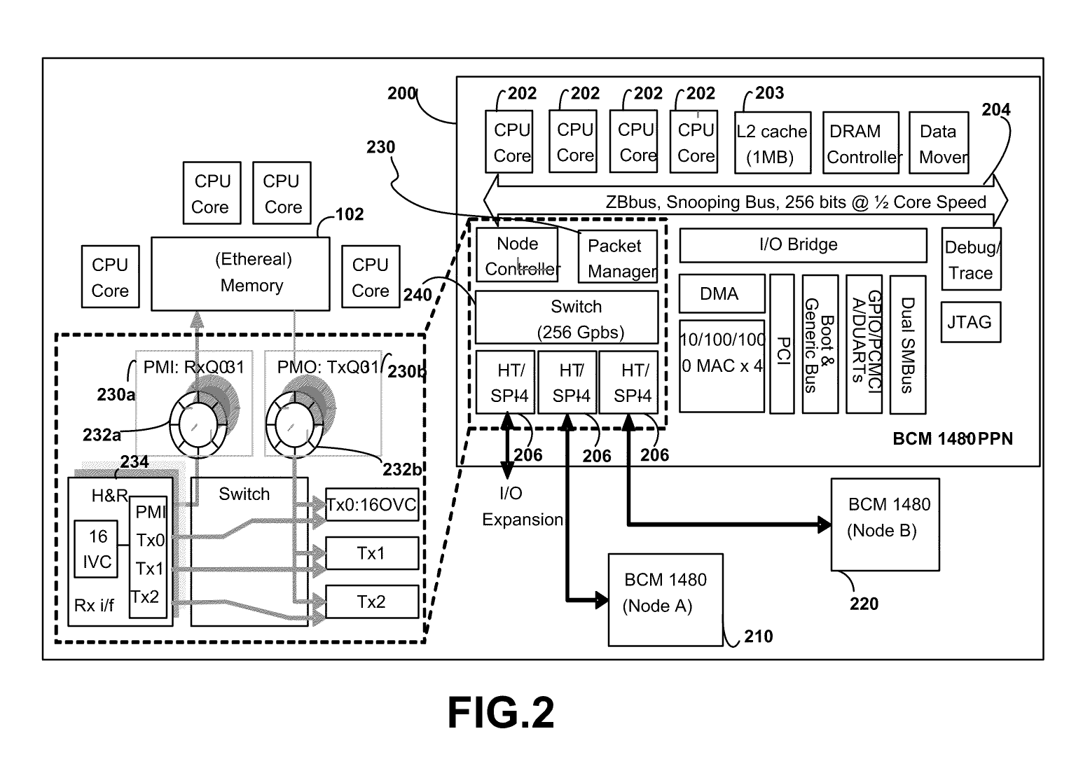

As shown in FIG. 2 below, an exemplary “system-on-a-chip” (“SoC”) processor 200 (e.g., a Broadcom BCM 1480 chip) for performing network processing with Ethereal Memory can contain four embedded Microprocessor without Interlocked Pipeline Stages (“MIPS”) cores 202. The MIPS cores 202 can be connected by a high-speed internal bus 204 (known herein as a ZBbus) that connects, among other things, the CPU cores and memory. The CPU cores 202 can be fifth generation SB-1™ CPU's that implement the MIPS64 instruction set architecture (“ISA”), and each core can have its own 32 KB level-one (L1) data and 32 KB instruction cache, which is backed up by a unified 1 MB, level-two (L2) cache 203. The non-blocking data cache supports 8 outstanding misses.

The BCM 1480 chip of FIG. 2 can include three high-speed HyperTransport/SPI-4 ports (which can be configured independently to operate in the HyperTransport (HT) or the SPI-4.2 mode, or be turned off to conserve power) and four Gigabit Ethernet ports to offer connectivity of commendable bandwidth. The BCM 1480 chip can supports 8-bit or 16-bit HT links at all standard frequencies up to 800 MHz, for a total of 25.6 Gigabits per second (“Gbps”) in each direction per port.

FIG. 2 shows, in addition to details of a BCM 1480 chip, a system having three interconnected BCM 1480 SoC nodes 200, 210, and 220, which are arranged in a way such that one node 200 (the packet processing node, or “PPN”) is used for processing network packets. Three high-performance HyperTransport/SPI-4 ports and four Gigabit Ethernet ports provide connectivity of commendable bandwidth for supporting clusters. The node labeled 200 operates as the packet processing node (“PPN”) under study, and the other two nodes (Node A 210 and Node B 220) assimilate to clients and servers that are connected via the PPN 200. By clocking the HT ports at 400 MHz, each 16-bit wide port provides 12.8 Gbps bandwidth at double data rate. Thus, our evaluation platform likens to a system where the PPN has two 10GbE ports.

The Packet Manager (PM) 230 can include two parts—one for handing input packets (PMI) 230a and another for handing output packets (PMO) 230b. Both the PMI part 230a and the PMO part 230b can have many priority queues (e.g., 32) for complex quality-f-service (“QoS”) support, whereas we only describe two input and two output queues here. Henceforth, in reference to the PPN 220 {ReceiveQ0, TransmitQ0} and {ReceiveQ1, TransmitQ1} are denoted as the pair of input and output queues for connections to nodes A 210 and node B 220, respectively. Each queue can implement a FIFO descriptor ring 232a and 232b. An entry in the receive queue can contain an address for the packet buffer available to keep next packet, a length field specifying the size of the buffer, and a status field indicating if the buffer is free to use by the hardware or if the hardware has received and stored a valid packet in the buffer. On the transmit side, a queue entry includes a buffer address that points to a packet to be sent, a length field and a status field for completion.

Each HT port 206 can include a receive interface and a transmit interface. A 16K byte buffer divided into 1,024×16 B entries can be used to temporarily buffer packets. Similarly a Transmit interface can have a 4K bytes buffer, or 256×16 B entries. Note that these buffers can be partitioned to support three different types of traffics: (a) Cache coherence protocol command traffic for cache coherent non-uniform memory access (“cc-NUMA”), (b) I/O command traffic for peripheral component interconnect (“PCI”) expansion and, (c) Packet-over-HT (“PoHT”) traffic for inter-node messaging. PoHT traffic can be the vehicle used for emulation of Ethernet, and it is contemplated that communication between different nodes within a system can occur via Ethernet traffic, or any other network protocol traffic. The buffer size allocated for PoHT traffic can be 3,200 bytes and 640 bytes for receive and transmit respectively.

On the basis of PoHT, both the receive and transmit interfaces further support 16 Virtual Channels (VC). When a packet arrives at the receive HT port, the packet can be tagged with an Input Virtual Channel (IVC) number. Based on the IVC and pre-determined rules, a Hash-and-Route (“H&R”) block 234 can deliver the packet to one of the 32 local PMI queues, or route it out to an Output Virtual Channel (OVC) of one of the three transmit interfaces. Thus, the H&R block 234 can act as a simple classifier as in FIG. 1. Packets of interest can be streamed to the user-level service processes through a dedicated PMI queue, and other packets can be sent to the Linux kernel via another PMI queue. This shows a non-intrusive way for tagging the APPEAL framework to the existing kernel stack.

The APPEAL-based model for processing network packets stands out by first sharing the packet buffers directly between the hardware level and the processes running in the user space level, so that the user level processes can access packets in the hardware buffers without the packets needing to be copied first from a kernel space buffer to a user-space buffer. The buffers of the Ethereal Memory 102 can be located in a physical memory device that is logically close to the CPU. For example, the buffers of the Ethereal Memory 102 can be located in a memory device connected to the CPU by a front side bus (“FSB”) or by a back side bus (“BSB”). Thus, the Ethereal Memory 102 can be connected to the CPU in a cache coherent manner that operates very fast. By receiving packets into buffers to which a user-level process has direct access, expensive memory copy operations in transferring packets between the kernel and the user space is eliminated.

Table 1 shows exemplary pseudo code that can be used for one implementation of this model. According to the pseudo-code, first, the user PPN process can open the Ethereal Memory device 102 and allocate a chunk of buffers in the Ethereal Memory. In this example shown in the pseudo code, 2,048×2 KB buffers are allocated and mapped into this user-space accessible Ethereal Memory. The user PPN process then can open a control socket to the PM device, and post the buffers to the device. The driver will assume the responsibility for managing these buffers, which form a buffer pool. The driver then can initialize the receive queues with the advertised buffers ready for receiving packets.

TABLE 1
Pseudo Code for an APPEAL-based PPN Model.

```
User PPN Process:
int main( )
{
  Open the /gmem/dev (Ethereal Memory Device)
  Allocate and map 2048×2KB buffers from the Ethereal Memory
  Open a socket to the PM device and post the packet buffer info
  to the device.
  for(;;) {
    // msg contains a list of buffer addresses and lengths.
        probe_dev(msg);
    for (each receive packet recorded in the msg structure)
                do_ppn_func(msg.buf[i], msg.len[i]);
    // do_ppn_func may alter the header and/or the
    // payload; after turning around, the same msg
    // structure contains the list of packets to be
    // forwarded to final destination.
      }
  }
PM Driver:
void prob_device(msg)
{// send packet
  For every packet in the buffer list, program the transmit queue.
  // send completion
  Probe transmit queues for completed tasks.
  Release buffer to the driver's buffer pool.
  // receive packet
  Probe receive queues.
  Re-use the same msg structure to pass addresses and length
  information of the received buffers to the user process.
  // Replenish the receive queues
  Allocate buffer from the pool and put buffers to the receive
  queues for next packets.
}
```

Communication between the user process and the driver can be achieved by a (ioctl) system call method supported by the driver. The user process may prepare a “message,” which specifies a list of packets to be sent. Then, when the drive is awoken by the system call, the driver can initiate a packet send for each specified packet in the message list, and then turn around by re-writing the same message list with information about received packets. Thus, the same message structure is used as a vehicle for both send and receive direction efficiently.

Note that there is no interrupt in this model, and pointers are of packets to be transmitted are passed along to the PM driver via a system call. The role of the kernel is reduced to supporting the system call interfacing the user process and the driver. Nonetheless, the overhead for taking system calls may still prove to be expensive. One way to mitigate this overhead is by conveying as much of the information for packet send and receive operations per system call. However, this overhead can be totally eliminated, by allocating the descriptor rings from the Ethereal Memory and mapping them into the user space as well. In this way, probing the receive queues and programming the transmit queues requires nothing more than simple memory accesses as shown in the pseudo code of Table 2 below.

TABLE 2
The All User PPN Model

```
User PPN Process:
int main( )
{
  Open the /gmem/dev (Ethereal Memory Device)
  Allocate and map 2048×2KB buffers from the Ethereal Memory, with
  the buffers managed by the application process itself.
  Allocate and map memory for the descriptor rings from the
  Ethereal Memory.
  Open and map the Hardware control registers.
  Set up the receive and transmit queues with the descriptor
  rings.
  for(;;)
    {
      Read next slot(buf, len) in the receive descriptor ring
      till a packet arrives.
      do_ppn_func(buf, len);
      Set next slot(buf,len) of the transmit queue.
    }
}
```

According to the pseudo code shown in Table 2, the user PPN process can open the Ethereal Memory device 102 and allocate a chunk of buffers in the Ethereal Memory. In this example shown in the pseudo code of Table 2, 2,048×2 KB buffers are allocated and mapped into this user-space accessible Ethereal Memory. Then, descriptor rings are allocated and mapped to the Ethereal Memory. Then, hardware control registers are opened and mapped, and Transmit and Receive queues are set up using the Ethereal Memory-based descriptor rings. Received packets are read from the Ethereal Memory-based descriptor rings, the packets are processed by a user-space application, and then next slot in the transmit queue is used to send the processed packet.

The performance of a PPN using the APPEAL architecture described herein can be compared to various other models that do not make use of Ethereal memory. These other modes mainly differ in the definition of memory regions from which resources such as packet buffers and descriptor rings are allocated, and in the methods for initiating packet send operations and for probing the PM device for received packet and send completion.

In a Baseline model the chip can be passive PPN that performs no functions on the network packets. This Baseline mode establishes a baseline for comparison to other models that perform network packet processing. In the Baseline model, packets flow through the on-chip switch 240 of the BCM 1480 PPN shown in FIG. 2 without ever being touched by a user process, as if Node A and Node B were connected via a cross-over cable.

In a conventional setting Linux-based User-Level PPN model leverages, as much as possible, the existing kernel services, without using Ethereal memory. In this conventional model the chip can allocated descriptor rings of PM's receive and transmit queues as well as packet buffers from the kernel space. Operations involving the Packet Manager (PM) are all performed by the driver, which resembles an Ethernet driver, and Table 3 shows the pseudo-code for this conventional model.

TABLE 3
Pseudo Code for the LU-PPN (conventional) Model.

| User PPN Process | PM Driver (Receive) | PM Driver (Trasnmit) |
|---|---|---|
| int main( ) | Void napi_poll( ) | Void pm_tx(skb_t*skb) // |
| { | { //receive packet | transmit packet |

| | | |
|---|---|---|
| Open a RAW_SOCK, sock | Read PM's Rx queue | { //transmit packet |

| for (;;){ | | If not packet | Add skb to the |
|---|---|---|---|
| | len=recv(sock,buf, ...); | arrives, return | descriptor ring of the |
| | do_ppn_func(buf,len); | //send up the stack | destination Tx queue. |

| | | |
|---|---|---|
| sendto(sock,buf,len ...); | netif_receive_skb( ); | } |
| } | allocate a new buffer | void tx_completion( ) |

| | | |
|---|---|---|
| } | & replenish the | { |

| | |
|---|---|
| receive queue | Probe transmit queues |

| | |
|---|---|
| } | and release completed |

buffers back to kernel
buffer pool.

}

To receive packets by the user service process, a RAW socket is opened to the hardware device. RAW sockets are often used in the early development phase for new transport protocols because they allow a user process to receive and send packets, with the packet header included, directly from and to the hardware interface. However, because RAW sockets allow users to craft packet headers themselves, the power of a RAW socket can be abused to perform feats such as IP address spoofing as part of a Denial-of-service attack. Because of their abusive power RAW sockets are only available to processes of super-user capability. Nevertheless, in the work, we use it as a convenient vehicle for demonstrating user-level packet processing, with the understanding that the kernel overhead (including protocol stack processing, context switch, memory copy) may prove too much to be bearable. The results provide a reference for evaluating the performance advantage offered by Ethereal Memory.

Using a Network Address and Port Translation (“NAPT”) process, the performance improvement achieved by the APPEAL architecture in terms of latency and throughput can be shown. In this test, the node A 210 of FIG. 2 initiates a TCP connection to a virtual IP address which is undertaken by the Network Address Translator (“NAT”) node (i.e., the node 200 labeled BCM 1480 PPN). The NAT node then imitates a load balancer that selects the private node B 220 of FIG. 2, and a second connection is relayed from the NAT node 200 to node B 220. The backtracked flow from node B 220 to node A 210 works in a similar way. To facilitate translation, the NAT node uses a simple hash table, which uses the unique tuple: (source IP, source port number, destination IP, destination port number) as the lookup key. Output of the lookup includes the new IP addresses, port numbers and pre-calculated values for fast checksum updates. In brief, the new checksum value is calculated as ˜(˜old checksum+˜m+m′), where m is the old fields (e.g., the IP address) replaced by the new value m′. We pre-calculate the adjustment value of (˜m+m′) when the NAT transits are first established. After the connections are set up, a chunk of data, assimilating to a file is retrieved by node A 210 from the node B 220.

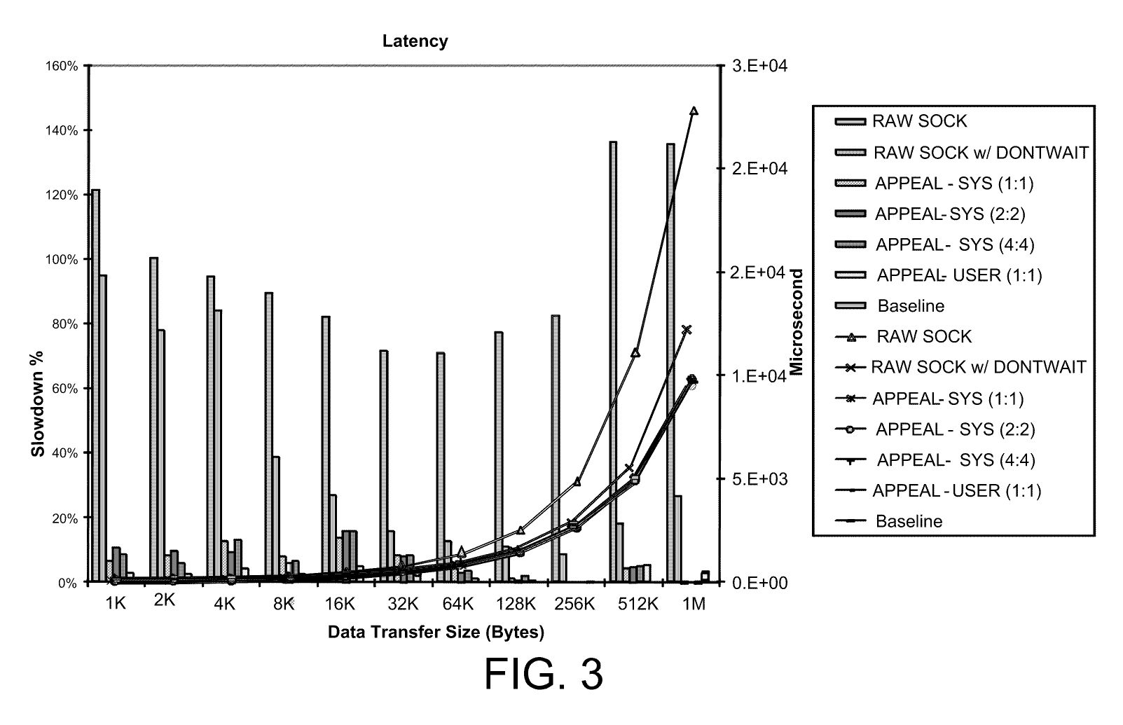

FIG. 3 is a graph that shows the average latency for various sizes of data transfers. All latency numbers are taken from the BCM 1480 chip hardware counter, which is a 64 b counter that is increased by one on every system bus cycle. To measure an event, the hardware counter is read before and after the event and the difference is calculated. The baseline model serves as a reference point, where the middle node is passive. In this Baseline case, data flow through the on-chip switch of the BCM 1480 chip and no NAT operation is performed. As a result, the baseline gives the (intuitive) lowest bound for latency.

From FIG. 3 it is evident that as high as a 140% slowdown is observed when the “blocking” RAW socket interface is used to deliver packets between the user process and the hardware. Two factors contribute to the slow-down. One is the memory copy operation; another is the overhead to add the process into a wait queue when there is no received packet waiting in the queue, and subsequently to wake up the process when packets arrive. In this case, the latter process dominates the latency result. When the DONTWAIT flag is asserted for the socket, the slowdown has a maximum of 95% and dwindles to 10% or 20% for large data transfers. A DONTWAIT flag instructs the kernel not to put the process into sleep, but rather a “try-again” status is returned. Subsequently, the process will probe again. Overall, per recvo call costs about 4.9 microseconds in our studied platform. When the transfer size is small, any extra delay caused by the recvo call, and by copying the packet between the user and the kernel space become significant. By increasing the transfer size, it is increasingly likely to find packets waiting to be processed. However, the cost for memory copy becomes high.

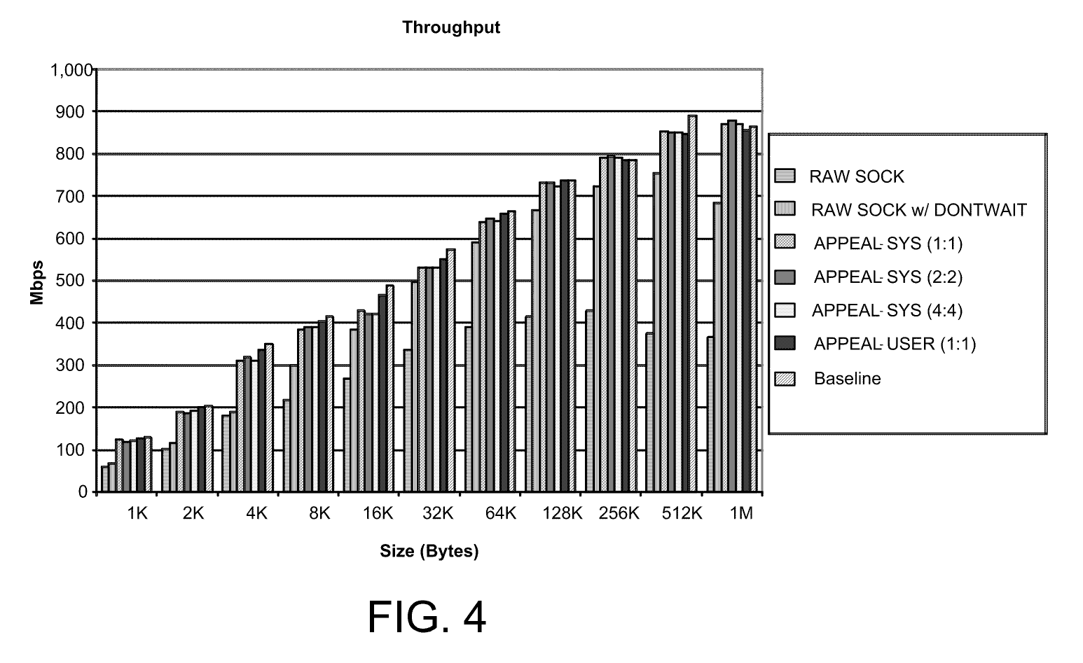

By contrast, the APPEAL framework performs exceptionally well and, almost regardless of the method used to access the receive and transmit queues. Initially, we see that when using the APPEAL framework the latency increased by 5% to 10% for small data transfers because the extra trip for the packets to travel up-and-down the hardware interface and the memory in the NAT node. However, this extra cost is almost hidden when the data transfer size increases and a constant packet stream is hitting the NAT node. Because in an equilibrium state the NAT node will output a constant stream of packets, so long as the processor can perform the NAT in time before the transmit hardware can drain all prior packets. For the studied platform, to drain a 1,500 (MTU, Maximum Transfer Unit) bytes packet, the transmit hardware needs to fetch roughly 48 (×32 B) memory blocks, which takes at least a few microseconds. On the other hand, a NAT operation can be completed within as quickly as 300 nanoseconds by our measurement. Thus, the extra latency does not show up for large data transfers, and the throughput results shown in FIG. 4 demonstrate that.

FIG. 4 is a graph showing throughput as a function of data transfer size for different transmission protocols and again shows that the throughput can be lowered significantly when system calls and memory copy operations are needed to achieve user-level packet processing. On the other hand, the APPEAL framework shows that throughput is relatively unaffected when compared to the baseline model. At some of the data points, the APPEAL even shows slight edge over the baseline, which can be considered within the margin of errors for statistics. Alternatively, the hardware flow-control mechanism may impose undue influence. Hereinabove, the evaluation platform of the BCM 1480 chip was described, especially, the small on-chip buffers included in each HT interface. Because the on-chip buffer space allocated for PoHT traffics is 640 bytes, which is rather small, when the next-hop node cannot sink data as quick as possible, there is a possibility that the flow control scheme will cause a back pressure to the source node. On the other hand, when the NAT node is in play, the extra memory hop can provide needed buffering to smooth out the traffic.

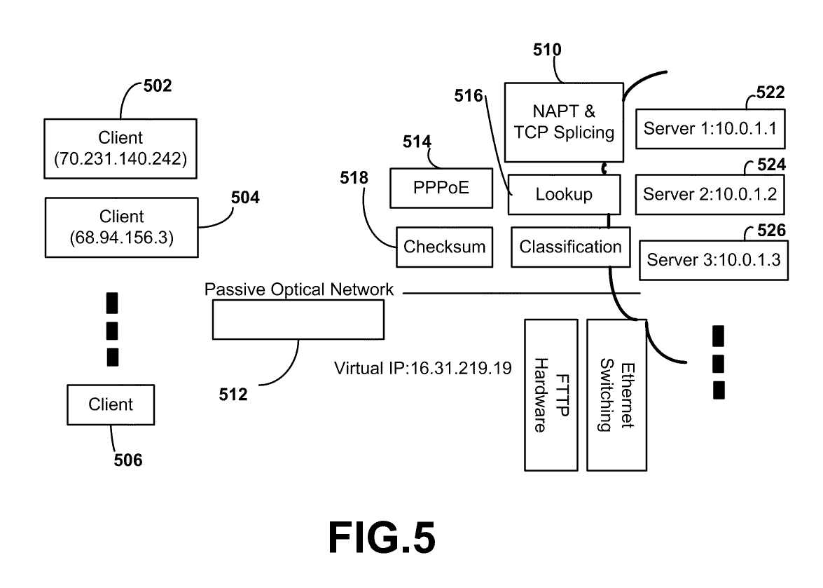

As the APPEAL framework is meant to benefit general packet processing, we can consider the breakdown of time spent on the data processing path, based on the client-server configuration demonstrated in FIG. 5, where up to 1024 clients 502, 504, 506 are requesting data from 128 servers 522, 524, 526. In our evaluation, client requests are made from Node A 210 (e.g., as in FIG. 2), whereas the servers are emulated by Node B 220, with the PPN node 210 acting as a proxy which performs NAPT (as outlined and evaluated in the last two sections) and TCP Splicing in an engine 510. Furthermore, it is assumed that the modeled Internet site deploys a leased FTTP (Fiber-To-The-Premises) line implementing a PON network (Passive Optical Network) 512. The de facto Point-to-Point Protocol over Ethernet (PPPOE) is adopted as the client-server protocol for data communication, encapsulating via a PPPoE engine 514 each packet flowing between a client and the proxy with a PPPoE header.

Our focus is limited to data path processing, given that a separate processor would normally be deployed to handle the control plane tasks, such as the discovery phase for establishing PPPoE sessions and the three-step handshake protocol for opening a TCP connection. This section evaluates the APPEAL framework for integrated services under an aggravating situation where a continuous stream of minimum sized packets (64 bytes) is initiated from clients 502, 504, 506 toward the PPN for integrated services, as highlighted below.

When a client makes a request for data from a server, a TCP connection is first established with a server. Upon receiving a SYN packet encapsulated in a PPPoE frame, a PPPoE engine 514 of the proxy (i.e., PPN) removes the PPPoE header, and then performs the three-step handshake protocol to complete the connection to the client. Subsequently, a private connection is established between the proxy and a selected server. Thus, the proxy node handles two connections per client-server session. An open hashbased lookup table 516 is used to keep the connections characterized by their unique tuples comprising the (source and destination) IP addresses and the (ingress and egress) port numbers at PPN. By applying NAPT, a plumbing transit between the client-to-proxy and proxy-to-server connections is created.

TCP splicing refers to a scheme which enables layer-4 content-aware switching. It unites the client-to-proxy and proxy-to-server connections by maneuvering the sequence numbers of packets, in a way stated in sequence. Assuming that seq1 and ack1 are the data and the acknowledgement sequence numbers of the first packet (e.g., in a HTTP GET message), which is received by the proxy and to-be-forwarded to a server, and that seq2 and ack2 are the modified sequence numbers of the packet actually sent to the server. Henceforth, the proxy adds the difference (seq2−seq1) to each data sequence number and (ack2−ack1) to the acknowledgement sequence number of each received packet from the client to the server. In the opposite server-to-client direction, the proxy subtracts (ack2−ack1) from the data sequence number and (seq2−seq1) from the acknowledgement sequence number of every packet. A pair of connections, one from a client to the proxy and another from the proxy to a server, establishes a client-server session, whose ID lookups are through hashing.

After NAPT and TCP splicing are performed by the engine 510, the checksum fields of the IP and the TCP headers are adjusted accordingly by the checksum engine 518. If a packet is sent by the server to the client, a PPPoE header is inserted between the Ethernet header and the IP header by the PPPoE engine 514. A TCP splicing code plus the checksum modification code are implemented in the application layer, together with the NAPT code and those codes listed in Table 2 constitute packet processing for integrated services run on PPN of our evaluation platform.

In our evaluation, two random sets of connections were created, one for specifying those between the clients (generated by Node A, see FIG. 2) and the proxy and the other for defining the associated connections between the proxy and the local servers (situated in Node B). A connection in the first set (e.g., [68.94.156.3:1500, 16.31.219.19:80] illustrated in FIG. 5) is paired with another connection ([16.31.219.19:1764, 10.0.1.2:80]) in the second set; applying NAPT and TCP splicing to the two connections forms one client-server session.

The number of client-server sessions of interest chosen in each run varies from 32 to 1024 (and thus the number of connections managed at the proxy ranges from 64 to 2048, as a session involves two connections). The proxy 200 (i.e., PPN) uses a simple open hash-based table of 256 buckets for session ID lookups. When collision occurs, a linked list is formed. The search key to the hash table is the session-unique identifier, which comprises the source IP address, the source port number, the destination IP address and the destination port number.

Traffic through the proxy contains minimum sized packets (of 64 bytes each, the smallest Ethernet frame) to random sessions from both directions. Because the packet processing time is independent of the payload size, a continuous stream of minimum sized packets represents the most aggravating case.

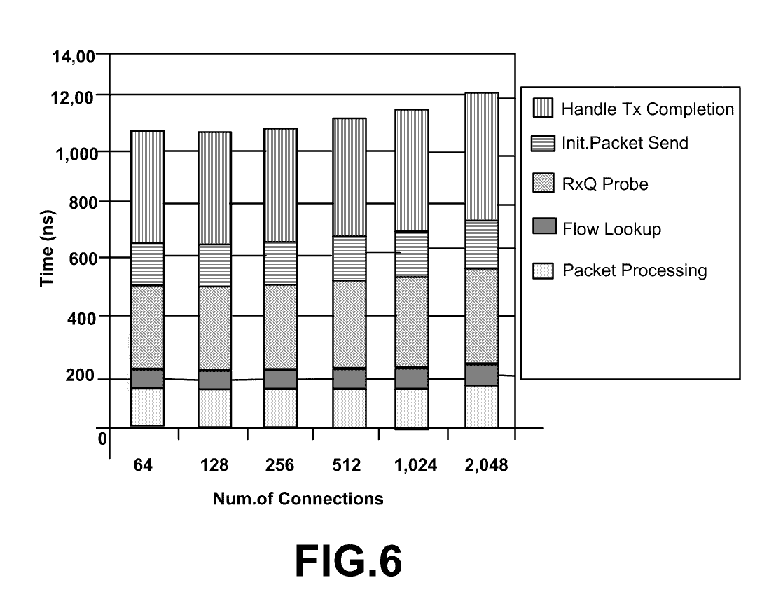

FIG. 6 is a graph of packet elapse time as a function of the number of connections under the APPEAL setting, where the breakdown of all services involved for a packet to pass through PPN is included. As can be seen, the time involved in packet processing is very short in all cases. In fact, all the data-path functions related to packet processing described above can be completed in less than 170 ns. The session ID lookup operation is relatively expensive, and it grows as the number of connections increases. For a simple open hash method as we adopted, the existence of a large number of connections result in many hash collisions, and subsequently a long search path.

The proxy node when using an APPEAL framework exhibits the packet processing rate of 5.8 Mpps (million packets per second), given the actual packet processing time of 170 ns. It sustains some 0.95 Mpps (or 0.81 Mpps) under the number of connections equal to 64 (or 2048) when all the time elements are considered. Probing the receive queues and handling transmit completion are found to be most time consuming, accounting for 66% (or 56%) of the total elapse time for a packet to pass through PPN. They involve accessing the descriptors and managing packet buffers. First of all, the descriptors are a shared data structure between the processor and interface hardware. After interface hardware updates receive indication or send completion, accesses to the descriptors usually result in essential cache misses. As a result, an ideal design may bring the descriptor close to the processor such as placing them in fast on-chip SRAM.

Memory-related buffer management is a more imperceptible problem than long latency accesses to descriptors. When probing hardware for packet reception, the receive interface has to be replenished with new buffers in order not to drop packets, and on send completion, freed buffers need to be put back to the resource pool. Managing the buffer resources can be a critical issue for keeping up with high speed links, due to its excessive overhead, and this is especially true when the majority of traffic comprises small packets. The descriptors are consumed quickly, used buffers for completed send are required to be expeditiously released, and receive buffers need to be allocated and supplied rapidly, which make it difficult for the system to keep up.

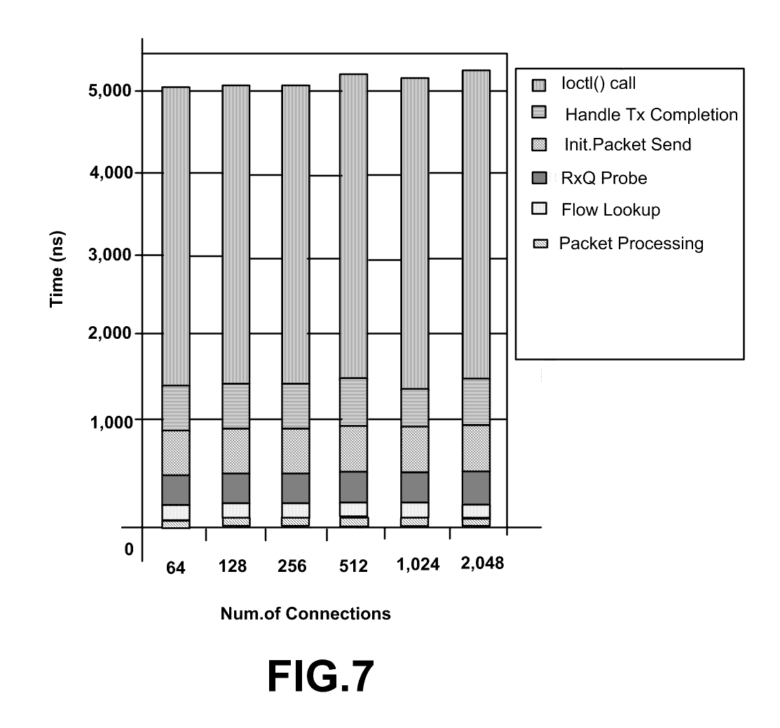

Latency analysis, shown above with respect to FIG. 6 shows that the extra latency caused by the ioctl( ) system call used to probe the hardware queues does not prolong the time required to transfer large amount of data when using the pseudo code shown in Table 2. As explained before, the hardware takes a few microseconds to drain a 1,500-byte (maximum transfer unit (“MTU”)-size) packet. Therefore, in an equilibrium state of continuous 1,500-byte packets, the overhead for the system call is deceptively hidden. Unfortunately, this is not the case for small packets, which results are shown in FIG. 7, which is a graph of packet elapse time as a function of the number of connections under the APPEAL setting. As shown in FIG. 7, when the proxy node is bombarded by minimum size packets, the system call overhead can hurt the processor's capacity for packet processing, in that the system can takes roughly extra 3.8 microseconds to handle the ioctl( ) call, effectively accounting for 75% of the total time. Due to this excessive overhead, the packet processing rate drops to 350 Kpps, which illustrates the importance of bypassing the kernel entirely.

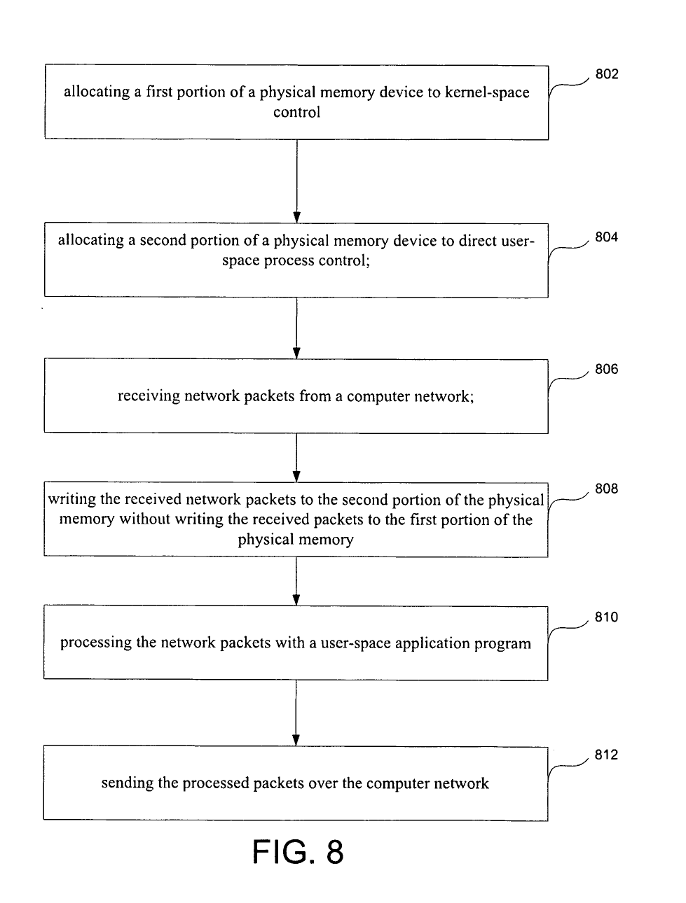

FIG. 8 is a flow chart of a process of processing network packets. In the process a first portion of a physical memory device is allocated to kernel-space control (802) and a second portion of the physical memory device to direct user-space process control (804). Network packets can be received from a computer network (806), and the received network packets can be written to the second portion of the physical memory without writing the received packets to the first portion of the physical memory (808). The network packets can be processed with a user-space application program that directly accesses the packets that have been written to the second portion of physical memory (810), and the processed packets can be sent over the computer network (812).

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) for use with the methods and apparatuses described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
allocating a first portion of a physical memory device to kernel-space control;
allocating a second portion of a physical memory device to direct user-space process control;
receiving network packets from a computer network;
writing the received network packets to the second portion of the physical memory without writing the received packets to the first portion of the physical memory;
processing the network packets with a user-space application program; and
sending the processed packets over the computer network.

2. The method of claim 1, wherein the application program is executed by a CPU, and wherein the physical memory device is coupled to a CPU via a front side bus.

3. The method of claim 1, wherein the application program is executed by a CPU, and wherein the physical memory device is coupled to a CPU via a back side bus.

4. The method of claim 1, wherein the application program is executed by a CPU that is coupled to a cache, and wherein the physical memory device is coupled to a cache in a coherent manner.

5. The method of claim 1, wherein the application program is executed by a CPU, and wherein the physical memory device is coupled to a CPU via a front side bus.

6. The method of claim 1, further comprising receiving the network packets from the computer network with a hardware device.

7. The method of claim 6, wherein the hardware device is a network interface card.

8. The method of claim 1, wherein the second portion of physical memory is not available to the kernel.

9. The method of claim 6, further comprising defining receive buffers in the second portion of the physical memory device.

10. The method of claim 1, wherein the user-space application program comprises a network address translation program, an encryption program, a network intrusion detection program, a point-to-point over Ethernet program, a firewall program, a secure socket layer program, or a security program.

11. The method of claim 1, further comprising opening the second portion of the physical memory device as a memory device.

12. The method of claim 1, wherein the physical memory device is a DRAM device.

13. The method of claim 1, wherein the physical memory device is a SRAM device.

14. The method of claim 1, further comprising defining the buffers into which the received packets are written in the second portion of the physical memory device.

15. The method of claim 1, further comprising defining the queues into which the received packets are written in the second portion of the physical memory device.

16. An apparatus for processing network packets sent from a first network device destined for a second network device, the apparatus comprising:
a general-purpose multi-core processor adapted for running;
a random access memory device including a first memory address space operating under kernel-space control and a second memory address space invisible to a kernel operating under direct control or a user space process,
a plurality of receive queue configured for storing data receiving from the first network device;
a plurality of transmit queues configured for storing data for transmission to the second network device;
wherein the second memory address space includes a plurality of buffer addresses configured for buffering data received from the plurality of hardware receive queues before passing the data to an application under user-space control for processing and a plurality of buffer addresses configured for buffering data received an application under user-space control before passing the data to one of the transmit queues.

17. The apparatus of claim 16, wherein the general-purpose multi-core processor adapted for running an operating system to execute an application-layer packet processing program.

18. The apparatus of claim 17, wherein the application-layer packet processing program is a network address and port translation program.

19. The apparatus of claim 16, wherein the transmit queues comprise a descriptor ring allocated from the second memory address space, and wherein the receive queues comprise a descriptor ring allocated from the second memory address space.

20. The apparatus of claim 16, further comprising a first hypertransport link configured for communication with the first network device and a second hypertransport link configured for communication with the second network device.
